(19) United States
(12) Patent Application Publication
(10) Pub. No.: US 2026/0056556 A1
(43) Pub. Date: Feb. 26, 2026

(54) METHODS AND SYSTEMS FOR ROBOT LEARNING AND CONTROLLING A ROBOT

(71) Applicant: COLLABORATIVE ROBOTICS, Santa Clara, CA (US)

(72) Inventors: Brandon Porter, Santa Clara, CA (US); Michael Lammers, Santa Clara, CA (US); Justin Koch, Santa Clara, CA (US); Michael Vogelsong, Santa Clara, CA (US)

(21) Appl. No.: 19/305,515

(22) Filed: Aug. 20, 2025

Related U.S. Application Data
(60) Provisional application No. 63/685,622, filed on Aug. 21, 2024.

(51) Int. Cl. G05D 1/648; G05D 1/69; G05D 101/10; G05D 107/60; G05D 109/10

(52) U.S. Cl. CPC G05D 1/648; G05D 1/69; G05D 2101/10; G05D 2107/65; G05D 2109/10

(57) ABSTRACT

A method may include obtaining an artificial intelligence (AI) model configured to identify series of tasks to be performed by a robot in accordance with general parameters. The method may include obtaining data indicating a particular parameter corresponding to a particular environment. The method may include identifying, using the AI model, the particular parameter as corresponding to the particular environment. The particular parameter may be used by the AI model to identify the series of tasks to be performed by the robot such that the series of tasks are performed in accordance with the general and the particular parameters. The method may include identifying, using the AI model and the particular parameter, a series of tasks to be performed by the robot to complete an operation in the particular environment. The method may include causing the robot to autonomously perform the series of tasks in the particular environment.

### CROSS-REFERENCE TO RELATED APPLICATION

This patent application claims the benefit of and priority to U.S. Provisional App. No. 63/685,622 filed Aug. 21, 2024, titled “METHODS FOR ROBOT LEARNING,” which is incorporated in the present disclosure by reference in its entirety.

### FIELD

The embodiments discussed in the present disclosure are related to methods and systems for robot learning and controlling a robot.

### BACKGROUND

Unless otherwise indicated in the present disclosure, the materials described in the present disclosure are not prior art to the claims in the present application and are not admitted to be prior art by inclusion in this section.

Robots have been used in recent years to perform tasks in various manufacturing, warehouses, logistics, and delivery settings. Robotics has been useful in making repetitive tasks more efficient, thereby improving efficiency and lowering costs.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a method. The method may include obtaining an artificial intelligence (AI) model configured to identify series of tasks to be performed by a robot in accordance with general parameters corresponding to a first environment. The method may also include obtaining input data indicating a particular parameter corresponding to a second environment. In addition, the method may include identifying, using the AI model, the particular parameter as corresponding to the second environment. Further, the method may include storing the particular parameter in an AI memory of the AI model. The stored particular parameter may be configured to be used in conjunction with the AI model to identify the series of tasks to be performed by the robot such that the series of tasks are performed in accordance with the general parameters corresponding to the first environment and in accordance with the stored particular parameter corresponding to the second environment. The method may include identifying, using the AI model and the stored particular parameter, a series of tasks to be performed by the robot to complete an operation in the second environment in accordance with the general parameters and the stored particular parameter. The method may also include causing the robot to autonomously perform the series of tasks in the second environment and complete the operation.

One or more embodiments of the present disclosure may include a system. The system may include one or more computer readable media configured to store instructions. The system may also include a processor coupled to the computer readable media. The processor may be configured to execute the instructions to cause or direct the system to perform operations. The operations may include obtaining an AI model configured to identify series of tasks to be performed by a robot in accordance with general parameters corresponding to a first environment. The operations may also include obtaining input data indicating a particular parameter corresponding to a second environment. In addition, the operations may include identifying, using the AI model, the particular parameter as corresponding to the second environment. Further, the operations may include storing the particular parameter in an AI memory of the AI model. The stored particular parameter may be configured to be used in conjunction with the AI model to identify the series of tasks to be performed by the robot such that the series of tasks are performed in accordance with the general parameters corresponding to the first environment and in accordance with the stored particular parameter corresponding to the second environment. The operations may include identifying, using the AI model and the stored particular parameter, a series of tasks to be performed by the robot to complete an operation in the second environment in accordance with the general parameters and the stored particular parameter. The operations may also include causing the robot to autonomously perform the series of tasks in the second environment and complete the operation.

One or more embodiments of the present disclosure may include a non-transitory computer-readable medium. The non-transitory computer-readable medium having computer-readable instructions stored thereon that are executable by a processor to perform or control performance of operations. The operations may include obtaining an AI model configured to identify series of tasks to be performed by a robot in accordance with general parameters corresponding to a first environment. The operations may also include obtaining input data indicating a particular parameter corresponding to a second environment. In addition, the operations may include identifying, using the AI model, the particular parameter as corresponding to the second environment. Further, the operations may include storing the particular parameter in an AI memory of the AI model. The stored particular parameter may be configured to be used in conjunction with the AI model to identify the series of tasks to be performed by the robot such that the series of tasks are performed in accordance with the general parameters corresponding to the first environment and in accordance with the stored particular parameter corresponding to the second environment. The operations may include identifying, using the AI model and the stored particular parameter, a series of tasks to be performed by the robot to complete an operation in the second environment in accordance with the general parameters and the stored particular parameter. The operations may also include causing the robot to autonomously perform the series of tasks in the second environment and complete the operation.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which autonomous robots may operate;

FIGS. 2A and 2B illustrate an example operational environment in which the autonomous robot of FIG. 1 may operate;

FIGS. 3A and 3B illustrate an example operational environment in which the autonomous robot of FIG. 1 may operate;

FIG. 4 illustrates a flowchart of an example method to cause a robot to autonomously perform a series of tasks in accordance with general parameters and a particular parameter corresponding to a second environment;

FIG. 5 illustrates an example computing system that may be used to cause a robot to autonomously perform a series of tasks in accordance with general parameters and a particular parameter corresponding to a second environment,

all according to at least one embodiment described in the present disclosure.

### DETAILED DESCRIPTION

Robots may perform various tasks based on various rules or parameters to complete an operation. The robots may receive instructions or input data that specify the operation that is to be completed. The robots may identify, perform, or both (generally referred to as “perform” in the present disclosure) the tasks based on the rules and parameters. In some robot systems, the robots may be configured to perform the tasks based on general rules or general parameters (generally referred to as “general rules or parameters” in the present disclosure) that correspond to a first environment (e.g., a general environment).

The first environment may include an operational setting, facility, or environment that is similar but still different than a second environment. For example, the first environment may include a first hospital that includes first features and aspects and the second environment may include a second hospital that includes second features and aspects. Some example features or aspects of the second environment may include a layout that is different than the first environment, objects that are specific to the second environment, or any other appropriate feature or aspect.

The first environment and the second environment may include different parts of a single environment (e.g., building, area, or region). The single environment may be divided into multiple sections or areas that each have distinct characteristics or requirements. In some embodiments, the first environment may include a general or baseline configuration that applies to the single environment. The second environment may include a specific part of the single environment that has unique features or parameters. For example, the single environment may include a multi-story structure where each floor has different layouts, equipment, or operational requirements. Accordingly, the first environment may include one floor of the structure and the second environment may include a different floor of the structure.

In addition, the second environment may include rules that are different than the first environment. For example, the second environment may include rules about areas in which the robots may (e.g., “go” zones) or may not (e.g., “no-go” zones) traverse that are different than the first environment. As another example, the second environment may include rules that change based on various factors such as environmental conditions, events, codes, or alerts that are specific to the second environment.

Some robots may not be capable of learning or updating the rules or parameters. These robots may operate using only the general rules or parameters (e.g., pre-defined rules or parameters) to perform the tasks and complete the operations. Therefore, these robots may not be able to adapt to changes in the environment, changes to rules, changes in context of the environment, changes in parameters, occurring events, moving between different environments, changes caused by the robots, or changes to any other appropriate dynamic aspect. For example, a portion of an environment may have recently been cleaned and these robots may enter this portion of the environment to try and clean it more or before the portion of the environment is ready (e.g., dry) for the robots to enter.

In addition, the general rules or parameters may be improper, incomplete, or insufficient for different environments (e.g., the second environment or a dynamic environment). Consequently, the general rules or parameters may not apply to particular aspects of the second environment. Further, the general rules or parameters may not be in accordance with practices or preferences of operators in the second environment. Additionally or alternatively, the general rules or parameters may not include or correspond to events that occur in the second environment due to specialized practices or situations that occur in the second environment.

Accordingly, the robots may not be able to adapt or operate in different environments or dynamic environments.

A robot according to at least one embodiment described in the present disclosure may include an AI model that is initially configured to identify series of tasks in accordance with the general rules or parameters corresponding to the first environment (e.g., general parameters). The robot may receive input data indicating particular rules or parameters (e.g., particular parameters) corresponding to a second environment. For example, the robot may periodically or consistently identify the particular rules or parameters in the input data and store the identified particular rules or parameters in an AI memory of the AI model. The AI model may store the particular rules or parameters so as to identify the series of tasks in accordance with both the general rules or parameters and the particular rules or parameters.

The AI model storing the particular rules or parameters may modify a manner in which the AI model identifies the series of tasks. The stored particular rules or parameters may function as contextual modifiers that influence how the AI model identifies the series of tasks. For example, the AI model may access the stored particular rules or parameters to evaluate whether the particular rules or parameters influence or indicate how the robot is to operate for a current scenario. Therefore, the robot may identify the series of tasks based on the particular rules or parameters of the second environment and based at least in part on the general rules or parameters of the first environment.

In one example, the robot may obtain the AI model configured to identify series of tasks to be performed by the robot in accordance with general parameters corresponding to the first environment. The robot may also obtain input data indicating a particular parameter corresponding to the second environment. In addition, the robot may identify, using the AI model, the particular parameter as corresponding to the second environment. Further, the robot may store the particular parameter in the AI memory of the AI model. The stored particular parameter may be configured to be used in conjunction with the AI model to identify the series of tasks to be performed by the robot such that the series of tasks are performed in accordance with the general parameters corresponding to the first environment and in accordance with the stored particular parameter corresponding to the second environment. The robot may identify, using the AI model and the stored particular parameter, a series of tasks to be performed by the robot to complete an operation in the second environment in accordance with the general parameters and the stored particular parameter. The robot may also cause the robot to autonomously perform the series of tasks in the second environment and complete the operation.

The robot using the particular parameters to identify the series of tasks may enhance functionality, adaptability, or both of the robot. Likewise, the robot using the particular parameters to identify the series of tasks may permit the robot to adapt to new or dynamic environments.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

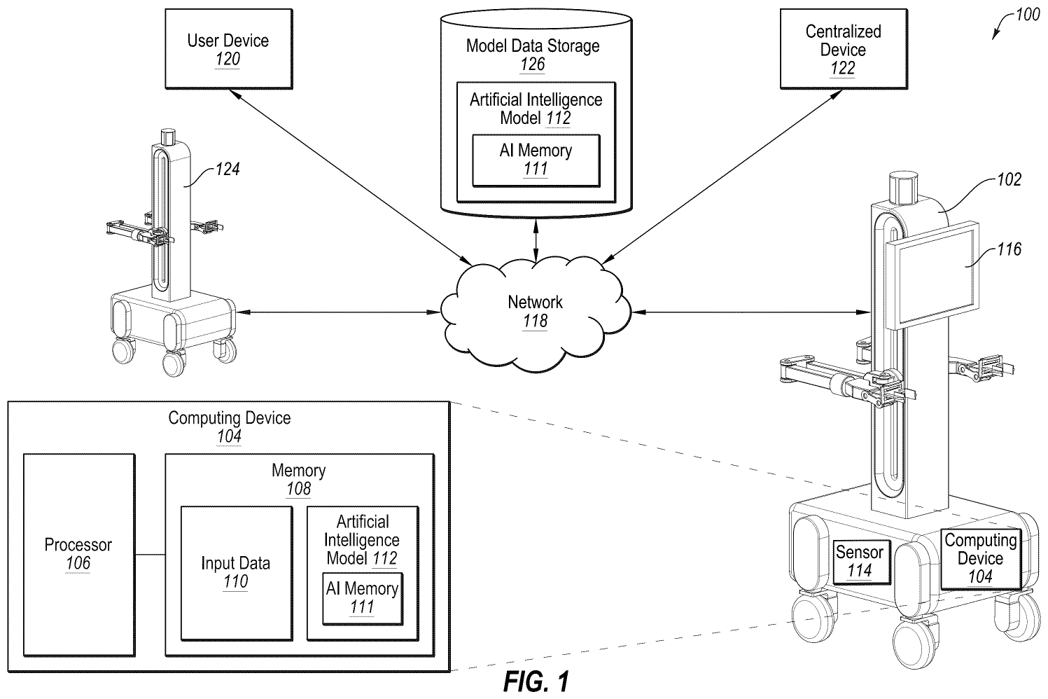

FIG. 1 illustrates a block diagram of an example operational environment 100 in which autonomous robots 102, 124 (referred to in the present disclosure as robot 102 or robot 124) may operate, in accordance with at least one embodiment described in the present disclosure. The environment 100 may include any location in which the robots 102, 124 may operate. For example, the environment 100 may include a warehouse, a hospital, a campus, a building, a field, a construction site, and the like.

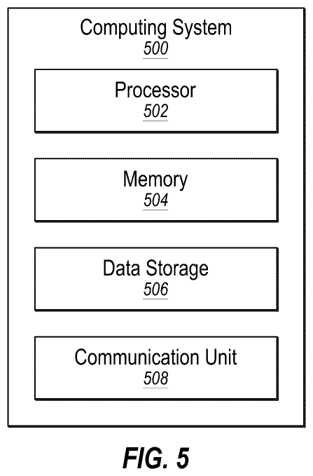

The robot 102 may include a computing device 104, which may include a desktop computer, a laptop computer, a smartphone, a mobile phone, a tablet computer, a server, a processing system, or any other computing system or set of computing systems that may be used for performing the operations described in the present disclosure. An example of such a computing system is described below with reference to FIG. 5. The computing device 104 may include a processor 106 and a memory 108.

The processor 106 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 106 may be configured to execute computer instructions that, when executed, cause the processor 106 or the computing device 104, to perform or control performance of one or more of the operations described in the present disclosure with respect to operation of the robot 102. The processor 106 may be implemented using a combination of hardware and software. In the present disclosure, operations described as being performed by the processor 106 or the computing device 104 may include operations that the processor 106 or the computing device 104 directs a corresponding system to perform.

The memory 108 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The memory 108 may store computer instructions that may be executed by the processor 106 or the computing device 104 to perform or control performance of one or more of the operations described herein with respect to operation of the robot 102. In addition, the memory 108 may store an AI model 112, input data 110, or both persistently and/or at least temporarily.

The environment 100 may include a model data storage 126 that includes any memory or data storage. The model data storage 126 may include network communication capabilities such that other components in the environment 100 may communicate with the model data storage 126. For example, the computing device 104 may obtain the AI model 112 or any other appropriate data from the model data storage 126. In some embodiments, the model data storage 126 may include computer-readable storage media for carrying or having computer-executable instructions or data structures stored thereon. The computer-readable storage media may include any available media that may be accessed by a general-purpose or special-purpose computer, such as a processor. For example, the model data storage 126 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the model data storage 126.

The environment 100 may include a network 118 that includes any communication network configured for communication of signals between any of the components (e.g., 102, 120, 122, 124, or 126) of the environment 100. The network 118 may be wired or wireless. The network 118 may have numerous configurations including a star configuration, a token ring configuration, or another suitable configuration. Furthermore, the network 118 may include a local area network (LAN), a wide area network (WAN) (e.g., the Internet), and/or other interconnected data paths across which multiple devices may communicate. In some embodiments, the network 118 may include a peer-to-peer network. The network 118 may also be coupled to or include portions of a telecommunications network that may enable communication of data in a variety of different communication protocols.

In some embodiments, the network 118 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 118 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the components (e.g., 102, 120, 122, 124, or 126) of the environment 100.

The computing device 104 may obtain the AI model 112 from the model data storage 126 via the network 118. Alternatively, the computing device 104 may generate the AI model 112 locally. Examples of the AI model 112 include, but are not limited to, a large language model, a logic model, a rule-based model (e.g., if-then rules), a decision tree model, a convolutional neural network model, a linear regression model, a logistic regression model, a supervised learning model, an unsupervised learning model, a deep learning model, a machine learning model, any other appropriate AI model, or some combination thereof.

The AI model 112 may initially be configured to identify the series of tasks in accordance with general rules or parameters corresponding to a first environment. The AI model 112 may store the general rules or parameters in an AI memory 111. The general rules or parameters may include pre-programmed rules for operating in the first environment. However, The first environment and the environment 100 (e.g., the second environment) may be similar but not the same. For example, the environment 100 may include a particular hospital or a particular warehouse and the first environment may include a generic hospital, a generic warehouse, a different hospital, or a different warehouse. As another example, the environment 100 may include a different type of environment than the first environment.

The general rules or parameters may not apply to the environment 100 or may not be in accordance with practices or preferences of operators in the environment 100. For example, the general rules or parameters may not include or correspond to events that occur in the environment 100 due to specialized practices or situations that occur in the environment 100. Consequently, the environment 100 may include portions, aspects, or areas or may correspond to rules, parameters, practices, or procedures that are not included in or do not correspond to the first environment.

The robot 102 may receive user input that indicates the robot 102 is to complete an operation (e.g., a first operation). For example, the user device 120, the robot 102, or a centralized device 122 may display a graphical user interface (GUI) configured to receive the user input. As another example, a sensor 114 of the robot 102 may receive and generate data representative of verbal commands spoken by the operator. The user input may include instructions, prompts, or any other appropriate information regarding the operation that is to be completed.

The computing device 104 may execute the AI model 112 to identify a series of tasks (e.g., a first series of tasks) to complete the operation (e.g., a first operation) based on the user input and the input data 110. The AI model 112 may identify the first series of tasks based on or in accordance with the general rules or parameters. The AI model 112 may identify the first series of tasks based on the instructions received by the computing device 104 or alternatively in response to an event occurring proximate to the robot 102.

The computing device 104 may cause the robot 102 to autonomously perform the series of tasks in the environment 100. The AI model 112, the computing device 104, or both may generate executable commands for the robot 102 based on the series of tasks. Additionally or alternatively, the computing device 104 may generate signals to cause actuators (not shown in FIG. 1) of the robot 102 to activate and move the robot 102 to autonomously perform the series of tasks and complete the operation.

In response to the robot 102 autonomously performing the first series of tasks or any other appropriate time, the computing device 104 may obtain the input data 110 or updates to the input data 110. The input data 110 may indicate the particular rules or parameters corresponding to the environment 100. For example, the input data 110 may indicate practices, expectations, procedures, protocols, or any other appropriate factor regarding the environment 100. Additionally or alternatively, the input data 110 may include data collected by the sensor 114 from which the particular rules or parameters may be extracted. For example, the sensor 114 may include a camera or a video camera configured to capture image data from which operator behaviors, body language, reactions, gestures, verbal commands, natural language input, or actions proximate to the robot 102 (e.g., data from the operator via the sensor 114) may be extracted. Examples of the sensor 114 include a camera, a video camera, a Light Detection and Ranging (LiDAR) device, a radar device, an infrared device, a GPS device, other devices configured to capture images, or any other appropriate sensor.

The computing device 104 may display the GUI on a display 116 of the robot 102 through which the operator may provide the input data 110. The display 116 is illustrated in FIG. 1 as being positioned on or within the robot 102 for example purposes. For example, the display 116 may include a screen embedded in a frame, panel, or any other surface or portion of the robot 102. Alternatively, the display 116 may be external to the robot 102 (e.g., displayed via the user device 120 or the centralized device 122). The environment 100 may include a user device 120 configured to display the GUI through which the operator may provide the input data 110.

The centralized device 122 may monitor the environment 100 and provide the input data 110 based on identified actions of the robot 102. The user device 120, the centralized device 122, or both may include any appropriate computing system and may be the same as or similar to the computing device 104 and an example of such a computing system is described below with reference to FIG. 5..

The particular rules or parameters indicated in the input data 110 may include one or more of rules or parameters corresponding to a series of tasks to be performed by the robot 102. The particular rules or parameters may include contextual rules that are specific to the environment 100. The particular rules or parameters may indicate rules or parameters to be followed by the robot 102 responsive to an event occurring in the environment 100, rules or parameters corresponding to tasks being performed in a particular part of the environment 100, rules or parameters corresponding to a modification to a task to be made responsive to an event occurring in the environment 100, rules or parameters corresponding to an order of operations for tasks to be completed as part of a series of tasks, or rules or parameters corresponding to a series of tasks or a modification to a series of tasks to be made responsive to a particular operator being proximate to the robot 102.

The computing device 104 may execute the AI model 112 to process the input data 110 to identify or extract the particular rules or parameters. The AI model 112 may identify the particular rules or parameters as corresponding specifically to the environment 100. The computing device 104 may store the particular rules or parameters in the AI memory 111 to provide context specific to the environment 100 (e.g., the second environment). In addition, the computing device 104 may store the particular rules or parameters in the AI memory 111 to permit the AI model 112 to identify the series of tasks in accordance with the particular rules or parameters corresponding to the environment 100 and in accordance with the general rules or parameters corresponding to the first environment.

The AI model 112 may correlate the particular rules or parameters with the general rules or parameters in the AI model 112 to augment, replace, update, or verify the general rules or parameters in the AI memory 111. For example, the particular rules or parameters may correspond to a series of tasks to be performed in response to a code or other event occurring in the environment 100 and the AI model 112 may augment, replace, update, or verify the general rules or parameters accordingly. The AI memory 111 may include context windows that are configured to store text to be used as input to the AI model 112 when identifying the series of tasks to be performed by the robot 102.

The particular rules or parameters may alter weights of the AI model 112. Additionally or alternatively, the particular rules or parameters may cause the AI model 112 to apply different computational pathways when the particular rules or parameters indicate that specific environmental conditions or operational contexts are present. For example, when the stored particular parameters include rules about restricted areas during events, the AI model 112 may modify a path of a planning algorithm to exclude certain routes from consideration. The AI model 112 may also adjust a task prioritization logic based on the particular rules or parameters that specify different operational priorities for different environmental states.

The AI memory 111 may maintain associations between the particular rules or parameters and corresponding environmental situations. The AI model 112 may use these associations to determine when the particular rules or parameters should be applied.

The computing device 104 may receive user input or the input data 110 that indicates the robot 102 is to complete another operation (e.g., a second operation). Alternatively, the computing device 104 may determine the another operation is to be completed in response to an event occurring proximate to the robot 102. The computing device 104 may execute the AI model 112 after storing the particular rules or parameters in the AI memory 111 to identify another series of tasks (e.g., a second series of tasks) to be performed by the robot 102 to complete the another operation.

The AI model 112 may analyze the environment 100, the input data 110, or both to determine if the particular rules or parameters apply to a current situation. In response to determining the particular rules or parameters apply, the AI model 112 mat retrieve the particular rules or parameters from the AI memory 111. The AI model 112 may modify the instructions, a processing sequence, or any other appropriate aspect to incorporate the particular rules or parameters. In addition, the AI model 112 may analyze the environment 100, the input data 110, the particular rules or parameters, or some combination thereof to identify which of the general rules or parameters apply to the current situation. In response to identifying at least some of the general rules or parameters apply, the AI model 112 may retrieve the corresponding general rules or parameters. Accordingly, the AI model 112 may identify the another series of tasks by combining or in accordance with both the particular rules or parameters and the general rules or parameters.

The computing device 104 may cause the robot 102 to autonomously perform the another series of tasks in the environment 100. The AI model 112, the computing device 104, or both may generate executable commands for the robot 102 based on the another series of tasks. Additionally or alternatively, the computing device 104 may generate signals to cause actuators (not shown in FIG. 1) of the robot 102 to activate and move the robot 102 to autonomously perform the another series of tasks and complete the another operation.

The computing device 104 may provide the AI model 112, after storing the particular rules or parameters in the AI memory 111; the input data 110; or both, to the model data storage 126 or to the robot 124. The robot 124 may be the same as or similar to the robot 102. When the computing device 104 provides the input data 110 to the robot 124, the robot 124 may perform similar processes as the robot 102 to identify the particular rules or parameters and/or store them in corresponding instances of the AI memory 111. When the computing device 104 provides the AI model 112 after storing the particular rules or parameters in the AI memory 111 to the robot 124, the robot 124 may replace any instances of the AI model 112 with the updated version.

Modifications, additions, or omissions may be made to the environment 100 of FIG. 1 without departing from the scope of the present disclosure. The computing device 104 is illustrated and discussed as being located on the robot 102 for example purposes. In some embodiments, the computing device 104 may be located remote to the robot 102 and may form part of any appropriate network. For example, the computing device 104 may be located in a building positioned in or proximate to the robot 102, the user device 120, the centralized device 122, or any other appropriate computing system. In other embodiments, the computing device 104 may include a cloud computing device that is accessed via the Internet or any other appropriate communication network.

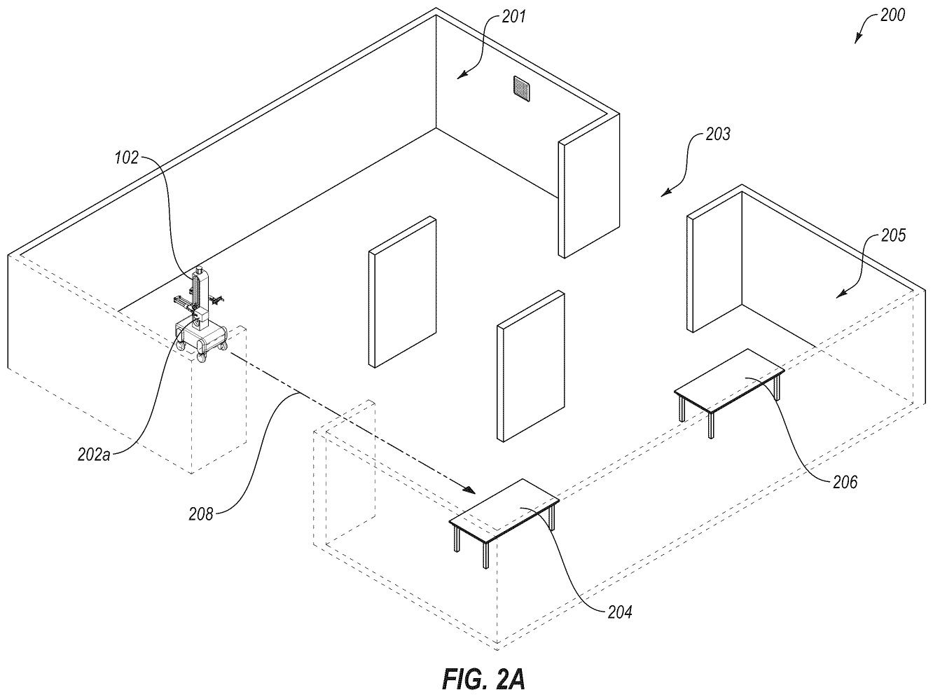

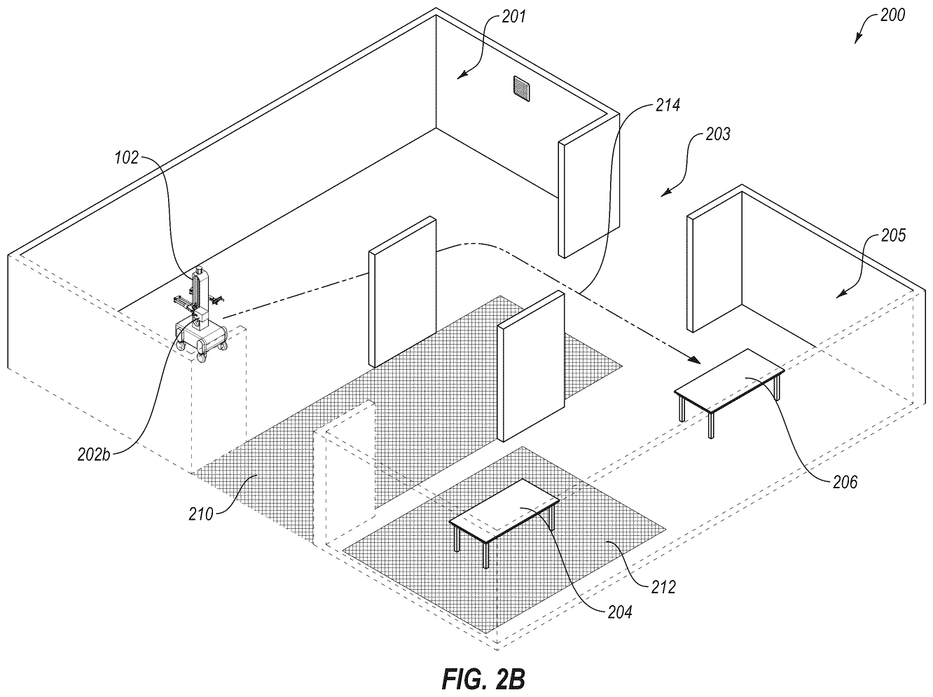

FIGS. 2A and 2B illustrate an example operational environment 200 in which the robot 102 of FIG. 1 may operate, in accordance with at least one embodiment described in the present disclosure. FIGS. 2A and 2B illustrate an example two-dimensional map that is representative of the environment 200. FIG. 2A illustrates a route 208 that may be identified by the computing device 104 based on the general rules or parameters. FIG. 2B illustrates a route 214 that may be identified by the computing device 104 based on the general rules or parameters and the particular rules or parameters.

Referring to FIGS. 1 and 2A, the computing device 104 may receive user input that indicates the robot 102 is to complete a first operation of “move the box from a first room to a second room.” Because the particular rules or parameters have not been stored in the AI memory 111, the computing device 104 may execute the AI model 112 to identify a first series of tasks to complete the first operation based only on the general rules or parameters. The AI model 112 may identify the first series of tasks as navigate proximate to the box 202a in a first room 201 (e.g., coordinates X1 and Y1 (not shown) based on the two-dimensional map included in the general rules or parameters), interact with the box 202a to pick it up, exit the first room 201 while holding the box 202a, traverse a hallway 203, enter a second room 205, navigate proximate to a first table 204 (e.g., coordinates X2 and Y2 (not shown) based on the two-dimensional map in the general rules or parameters), and place the box 202a on the first table 204. Accordingly, the robot 102 may navigate the route 208 illustrated in FIG. 2A because it is a direct route between the first room 201 and the location of the first table 204 in the second room 205. However, the AI model 112 may identify the first series of tasks and the route 208 based on or in accordance with only the general rules or parameters.

Referring to FIGS. 1 and 2B, in response to performing the first series of tasks or at any appropriate time, the computing device 104 may receive the input data 110 indicating a particular parameter of “do not drive through a portion of the hallway.” For example, the input data 110 may indicate that the portion of the hallway 203 was recently cleaned by another robot or an operator and the AI model 112 may determine that the robot 102 is to avoid that portion of the hallway 203 for a period of time. The input data 110 may highlight or otherwise mark the portion of the hallway 203 through which the robot 102 is not to traverse. The computing device 104, may add a “no-go” zone indicator 210 to the area of the two-dimensional map corresponding to the portion of the hallway 203. Additionally the input data 110 may indicate a particular parameter of “do not place objects on that table.” The input data 110 may highlight or otherwise mark the first table 204 that the robot 102 is not to place objects on. The computing device 104, may add a “no-go” zone indicator 212 to the area of the two-dimensional map corresponding to the first table 204.

The computing device 104 may receive user input that indicates the robot 102 is to complete a second operation of “move another box from the first room to the second room.” Because the particular rules or parameters have previously been stored in the AI memory 111, the computing device 104 may execute the AI model 112 to identify a second series of tasks to complete the second operation based on the general rules or parameters and the particular rules or parameters. For example, the AI model 112 may identify the second series of tasks as navigate proximate to a box 202b in the first room 201 (e.g., coordinates X3 and Y3 (not shown) based on the two-dimensional map in the general rules or parameters), interact with the box 202b to pick it up, exit the first room 201 while holding the box 202b, traverse the hallway 203 while avoiding the no-go zone represented by the no-go zone indicator 210 based on the particular rules or parameters, enter the second room 205, navigate proximate to a second table 206 (e.g., coordinates X4 and Y4 (not shown) based on the two-dimensional map in the general rules or parameters), and place the box 202b on the second table 206 because the no-go zone indicator 212 has been added to the two-dimensional map based on the particular rules or parameters. Accordingly, the robot 102 may navigate the route 214 illustrated in FIG. 2B because it avoids the no-go zone indicator 210 and positions the robot 102 proximate to the second table 206 to also avoid the no-go zone indicator 212 despite the route to the first table 204 being more direct.

In some embodiments, the computing device 104 may operate as if the portion of the hallway 203 corresponding to the no-go zone indicator 210 does not exist. In other embodiments, the computing device 104 may generate the commands to avoid the portion of the hallway 203 corresponding to the no-go zone indicator 210.

The examples are described above as using two no-go zone indicators (e.g., the no-go zone indicator 210 and the no-go zone indicator 212) for example purposes. The input data 110 may indicate any appropriate number of no-go zones such as zero, one, three, four, or more. Additionally or alternatively, the input data 110 may indicate any appropriate number of go zones (areas in which the robot 102 may traverse).

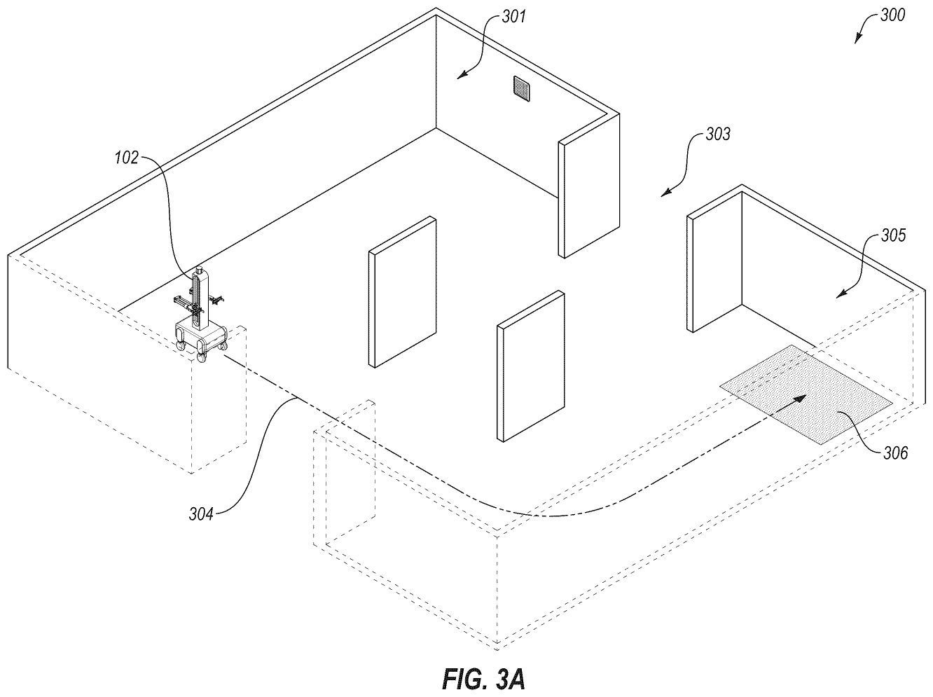

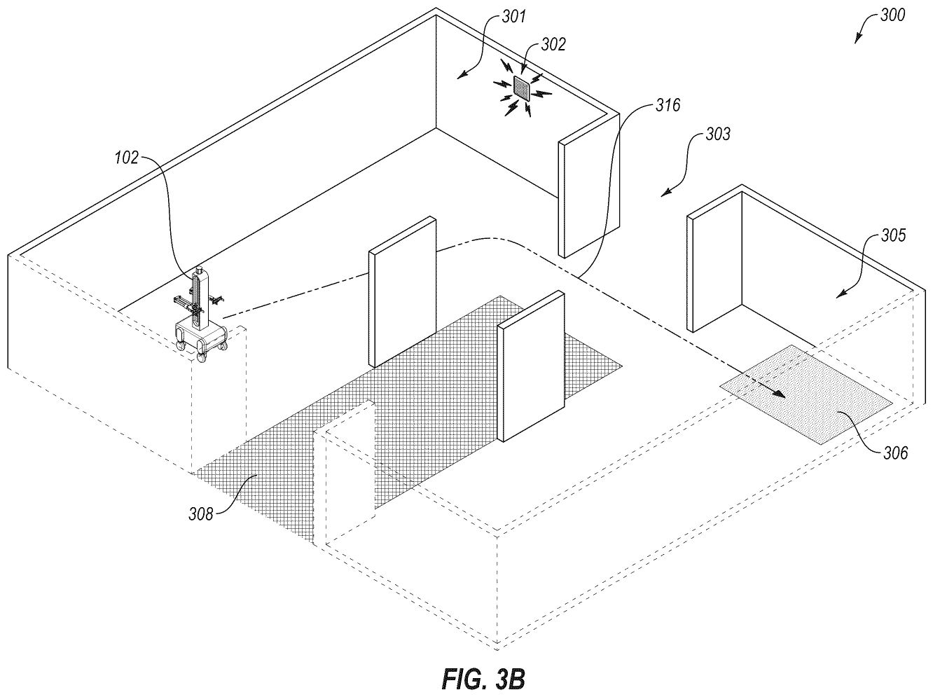

FIGS. 3A and 3B illustrate an example operational environment 300 in which the robot 102 of FIG. 1 may operate, in accordance with at least one embodiment described in the present disclosure. FIGS. 3A and 3B illustrate an example two-dimensional map that is representative of the environment 300. FIG. 3A illustrates a route 304 that may be identified by the computing device 104 when no code or event is occurring in the environment 300. FIG. 3B illustrates a route 316 that may be identified by the computing device 104 when a code or event is occurring in the environment 300.

Referring to FIGS. 1, 3A, and 3B, the computing device 104 may receive the input data 110 indicating a particular parameter of “do not drive through a portion of the hallway when a code is occurring.” The input data 110 may highlight or otherwise mark the portion of a hallway 303 through which the robot 102 is not to traverse. The computing device 104, may add a “no-go” zone indicator 308 to the area of the two-dimensional map corresponding to the portion of the hallway 303. Additionally the input data 110 may indicate a particular parameter of “here is your home area and position yourself within this area when a code is occurring.” The input data 110 may highlight or otherwise mark an area in the two-dimensional map that is the home area of the robot 102 and within which the robot 102 is to position itself when a code is occurring. The computing device 104, may add a “home” indicator 306 to the area of the two-dimensional map corresponding to the home area and within which the robot 102 is to position itself when a code is occurring.

At a first point in time, the computing device 104 may receive input that indicates the robot 102 is to complete a first operation of “go to the home area.” Because no code is occurring at the first point in time, the computing device 104 may execute the AI model 112 to identify a first series of tasks to complete the first operation without consideration of the no-go zone indicator 308. The AI model 112 may identify the first series of tasks as exit a first room 301, traverse the hallway 303, enter a second room 305, and navigate so as to position the robot 102 within the home area (e.g., the area corresponding to the home indicator 306 at coordinates X1 and Y1 (not shown) based on the two-dimensional map in the general rules or parameters and the particular rules or parameters). Accordingly, the robot 102 may navigate the route 304 illustrated in FIG. 3A because it is a route between the first room 301 and the second room 305 and positions the robot 102 within the home area represented by the home indicator 306.

At a second point in time, the computing device 104 may detect or determine that a code 302 is occurring. The code 302 is represented in FIG. 3B as a speaker playing an announcement or otherwise making sounds for example purposes. The code 302 may be indicated to the robot 102 via a direct message or any other appropriate method of communication. The computing device 104 may determine or detect the code 302 is occurring based on the input data 110 (e.g., sensor data obtained by the sensor 114), user input provided by an operator verbally; received via the GUI, or based on instructions from another robot). Accordingly, the computing device 104 may execute the AI model 112 to identify a second series of tasks to complete the operation of “position yourself within this area when a code is occurring” indicated in the particular rules or parameters. Accordingly, the AI model 112 may identify the second series of tasks as exit the first room 301, traverse the hallway 303 while avoiding the no-go zone represented by the no-go zone indicator 308 based on the particular rules or parameters, enter the second room 305, and navigate so as to position the robot 102 within the home area (e.g., the area corresponding to the home indicator 306 at coordinates X1 and Y1 (not shown) based on the two-dimensional map in the general rules or parameters and the particular rules or parameters). Accordingly, the robot 102 may navigate the route 316 illustrated in FIG. 3B because it avoids the no-go zone indicator 308 and positions the robot 102 within the home area represented by the home indicator 306.

The examples are described above as using on no-go zone indicator (e.g., the no-go zone indicator 308) and one home area (e.g., the home indicator 306) for example purposes. The input data 110 may indicate any appropriate number of no-go zones such as zero, two, three, four, or more. Additionally or alternatively, the input data 110 may indicate any appropriate number of go zones (areas in which the robot 102 may traverse). Further, the input data 110 may indicate any appropriate number of home areas such as zero, two, three, four, or more.

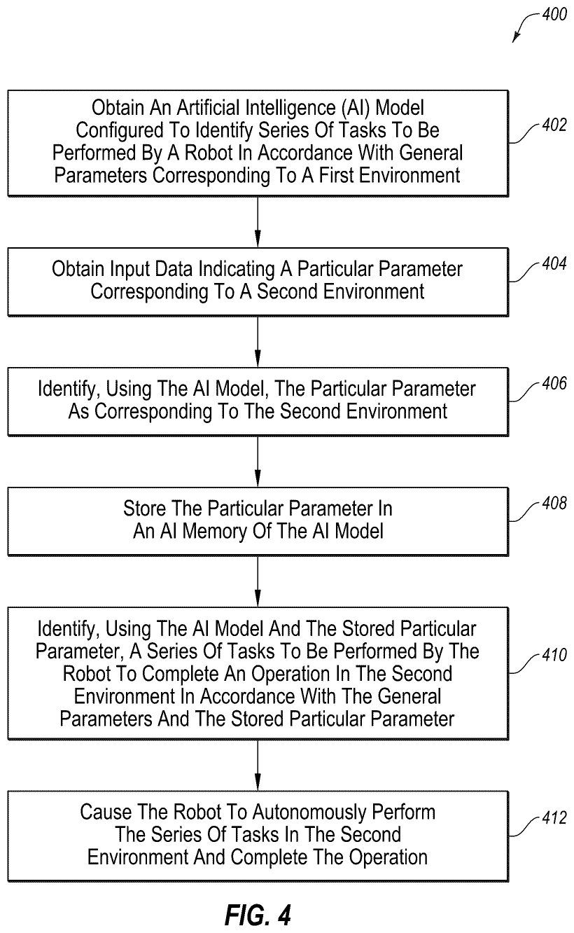

FIG. 4 illustrates a flowchart of an example method 400 to cause a robot to autonomously perform a series of tasks in accordance with general parameters and a particular parameter corresponding to a second environment, in accordance with at least one embodiment described in the present disclosure. The method 400 may be performed by any suitable system, apparatus, or device with respect to identifying the series of tasks to be performed by the robot. For example, the computing device 104 of or the centralized device 122 of FIG. 1 may perform or direct performance of one or more of the operations associated with the method 400. The method 400 may include one or more blocks 402, 404, 406, 408, 410, or 412. Although illustrated with discrete blocks, the steps and operations associated with one or more of the blocks of the method 400 may be divided into additional blocks, combined into fewer blocks, or eliminated, depending on the particular implementation.

At block 402, an AI model configured to identify series of tasks to be performed by a robot in accordance with general parameters corresponding to a first environment may be obtained. For example, the computing device 104 of FIG. 1 may obtain the AI model 112. The AI model 112 may be configured to identify series of tasks to be performed by the robot 102 in a first environment in accordance with the general rules or parameters.

At block 404, input data indicating a particular parameter corresponding to a second environment may be obtained. For example, the computing device 104 of FIG. 1 may obtain the input data 110. The input data 110 may indicate particular rules or parameters corresponding to the environment 100 of FIG. 1. At block 406, the particular parameter may be identified as corresponding to the second environment using the AI model.

At block 408, the particular parameter may be stored in an AI memory of the AI model. The stored particular parameter may be configured to be used in conjunction with the AI model to identify the series of tasks to be performed by the robot such that the series of tasks are performed in accordance with the general parameters corresponding to the first environment and in accordance with the stored particular parameter corresponding to the second environment. For example, the particular rules or parameters indicated in the input data 110 may be stored in the AI memory 111 of the AI model 112. The computing device 104 may execute the AI model 112 to identify the series of tasks based on the general rules or parameters and based on the particular rules or parameters stored in the AI memory 111.

At block 410, a series of tasks may be identified, using the AI model and the stored particular parameter, to be performed by the robot to complete an operation in the second environment in accordance with the general parameters and the stored particular parameter. For example, the computing device 104 of FIG. 1 may execute the AI model 112 to identify a second series of tasks to complete a second operation in the environment 100 in accordance with the general rules or parameters and the particular rules or parameters stored in the AI memory 111.

At block 412, the robot may be caused to autonomously perform the series of tasks in the second environment and complete the operation. For example, the computing device 104 of FIG. 1 may cause the robot 102 or transmit commands to actuators to cause the robot 102 to autonomously perform the series of tasks to complete the operation within the environment 100.

Modifications, additions, or omissions may be made to the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 5 illustrates an example computing system 500 that may be used cause a robot to autonomously perform a series of tasks in accordance with general parameters and a particular parameter corresponding to a second environment, in accordance with at least one embodiment of the present disclosure. The computing system 500 may be configured to implement or direct one or more operations associated with the robot 102, the robot 124, the computing device 104, the centralized device 122, or the user device 120. The computing system 500 may include a processor 502, memory 504, data storage 506, and a communication unit 508, which all may be communicatively coupled. In some embodiments, the computing system 500 may be part of any of the systems or devices described in this disclosure. For example, the computing system 500 may be configured to perform one or more of the tasks described above with respect to the computing device 104, the robot 102, the centralized device 122, or the user device 120.

The processor 502 may include any computing entity, or processing device including various computer hardware or software modules and may be configured to execute instructions stored on any applicable computer-readable storage media. For example, the processor 502 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 502 may include any number of processors distributed across any number of networks or physical locations that are configured to perform individually or collectively any number of operations described herein.

In some embodiments, the processor 502 may be configured to interpret and/or execute program instructions and/or process data stored in the memory 504, the data storage 506, or the memory 504 and the data storage 506. In some embodiments, the processor 502 may fetch program instructions from the data storage 506 and load the program instructions in the memory 504. After the program instructions are loaded into memory 504, the processor 502 may execute the program instructions.

For example, in some embodiments, the processor 502 may be configured to interpret and/or execute program instructions and/or process data stored in the memory 504, the data storage 506, or the memory 504 and the data storage 506. The program instruction and/or data may be related to an operator directed autonomous system such that the computing system 500 may perform or direct the performance of the operations associated therewith as directed by the instructions.

The memory 504 and the data storage 506 may include computer-readable storage media or one or more computer-readable storage mediums for carrying or having computer-executable instructions or data structures stored thereon. Such computer-readable storage media may be any available media that may be accessed by a computer, such as the processor 502.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 502 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 508 may include any component, device, system, or combination thereof that is configured to transmit or receive information over a network. In some embodiments, the communication unit 508 may communicate with other devices at other locations, the same location, or even other components within the same system. For example, the communication unit 508 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 508 may permit data to be exchanged with a network and/or any other devices or systems described in the present disclosure.

Modifications, additions, or omissions may be made to the computing system 500 without departing from the scope of the present disclosure. For example, in some embodiments, the computing system 500 may include any number of other components that may not be explicitly illustrated or described. Further, depending on certain implementations, the computing system 500 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,”etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or”is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining an artificial intelligence (AI) model configured to identify series of tasks to be performed by a robot in accordance with general parameters corresponding to a first environment;
obtaining input data indicating a particular parameter corresponding to a second environment;
identifying, using the AI model, the particular parameter as corresponding to the second environment;
storing the particular parameter in an AI memory of the AI model, the stored particular parameter being configured to be used in conjunction with the AI model to identify the series of tasks to be performed by the robot such that the series of tasks are performed in accordance with the general parameters corresponding to the first environment and in accordance with the stored particular parameter corresponding to the second environment;
identifying, using the AI model and the stored particular parameter, a series of tasks to be performed by the robot to complete an operation in the second environment in accordance with the general parameters and the stored particular parameter; and
causing the robot to autonomously perform the series of tasks in the second environment and complete the operation.

2. The method of claim 1 comprising:
identifying, using the AI model, another series of tasks to be performed by the robot to complete another operation in the second environment in accordance with the general parameters; and
causing the robot to autonomously perform the another series of tasks in the second environment and complete the another operation, wherein the obtaining the input data is performed responsive to the robot autonomously performing the another series of tasks.

3. The method of claim 1, wherein the input data comprises at least one of:
data from an operator obtained via a graphical user interface;
data from the operator obtained via a sensor;
data from another robot;
data representative of verbal commands provided by the operator;
data representative of gestures of the operator; or
data from a centralized device.

4. The method of claim 1, wherein the first environment comprises a generic hospital and the second environment comprises a particular hospital.

5. The method of claim 1, wherein the particular parameter indicates at least one of:
a rule corresponding to a series of tasks to be performed responsive to an event occurring;
a rule corresponding to a series of tasks being performed in a particular part of the second environment;
a rule corresponding to a modification to a series of tasks to be made responsive to an event occurring;
a rule corresponding to an order of operations for a series of tasks to be completed as part of a series of tasks; or
a rule corresponding to a series of tasks or a modification to a series of tasks to be made responsive to a particular operator being proximate to the robot.

6. The method of claim 1 comprising providing, to a plurality of robots, at least one of:
the input data to cause the plurality of robots to store the particular parameter in corresponding AI memories to permit the plurality of robots to execute stored AI models to identify series of tasks to be performed by the corresponding robot such that the series of tasks are performed in accordance with the general parameters corresponding to the first environment and in accordance with the stored particular parameter; or
the AI model with the particular parameter corresponding to the second environment stored in the AI memory.

7. The method of claim 1, wherein the AI memory comprises context windows configured to store text to be used as input to the AI model.

8. A system comprising:
one or more computer readable media configured to store instructions; and
a processor coupled to the computer readable media, the processor configured to execute the instructions to cause or direct the system to perform operations, the operations comprising:
obtaining an artificial intelligence (AI) model configured to identify series of tasks to be performed by a robot in accordance with general parameters corresponding to a first environment;
obtaining input data indicating a particular parameter corresponding to a second environment;
identifying, using the AI model, the particular parameter as corresponding to the second environment;
storing the particular parameter in an AI memory of the AI model, the stored particular parameter being configured to be used in conjunction with the AI model to identify the series of tasks to be performed by the robot such that the series of tasks are performed in accordance with the general parameters corresponding to the first environment and in accordance with the stored particular parameter corresponding to the second environment;
identifying, using the AI model and the stored particular parameter, a series of tasks to be performed by the robot to complete an operation in the second environment in accordance with the general parameters and the stored particular parameter; and
causing the robot to autonomously perform the series of tasks in the second environment and complete the operation.

9. The system of claim 8, the operations comprising:
identifying, using the AI model, another series of tasks to be performed by the robot to complete another operation in the second environment in accordance with the general parameters; and
causing the robot to autonomously perform the another series of tasks in the second environment and complete the another operation, wherein the obtaining the input data is performed responsive to the robot autonomously performing the another series of tasks.

10. The system of claim 8, wherein the input data comprises at least one of:
data from an operator obtained via a graphical user interface;
data from the operator obtained via a sensor;
data from another robot;
data representative of verbal commands provided by the operator;
data representative of gestures of the operator; or
data from a centralized device.

11. The system of claim 8, wherein the first environment comprises a generic hospital and the second environment comprises a particular hospital.

12. The system of claim 8, wherein the particular parameter indicates at least one of:
a rule corresponding to a series of tasks to be performed responsive to an event occurring;
a rule corresponding to a series of tasks being performed in a particular part of the second environment;
a rule corresponding to a modification to a series of tasks to be made responsive to an event occurring;
a rule corresponding to an order of operations for a series of tasks to be completed as part of a series of tasks; or
a rule corresponding to a series of tasks or a modification to a series of tasks to be made responsive to a particular operator being proximate to the robot.

13. The system of claim 8, the operations comprising providing, to a plurality of robots, at least one of:
the input data to cause the plurality of robots to store the particular parameter in corresponding AI memories to permit the plurality of robots to execute stored AI models to identify series of tasks to be performed by the corresponding robot such that the series of tasks are performed in accordance with the general parameters corresponding to the first environment and in accordance with the stored particular parameter; or
the AI model with the particular parameter corresponding to the second environment stored in the AI memory.

14. The system of claim 8, wherein the AI memory comprises context windows configured to store text to be used as input to the AI model.

15. A non-transitory computer-readable medium having computer-readable instructions stored thereon that are executable by a processor to perform or control performance of operations comprising:
obtaining an artificial intelligence (AI) model configured to identify series of tasks to be performed by a robot in accordance with general parameters corresponding to a first environment;
obtaining input data indicating a particular parameter corresponding to a second environment;
identifying, using the AI model, the particular parameter as corresponding to the second environment;
storing the particular parameter in an AI memory of the AI model, the stored particular parameter being configured to be used in conjunction with the AI model to identify the series of tasks to be performed by the robot such that the series of tasks are performed in accordance with the general parameters corresponding to the first environment and in accordance with the stored particular parameter corresponding to the second environment;
identifying, using the AI model and the stored particular parameter, a series of tasks to be performed by the robot to complete an operation in the second environment in accordance with the general parameters and the stored particular parameter; and
causing the robot to autonomously perform the series of tasks in the second environment and complete the operation.

16. The non-transitory computer-readable medium of claim 15, the operations comprising:
identifying, using the AI model, another series of tasks to be performed by the robot to complete another operation in the second environment in accordance with the general parameters; and
causing the robot to autonomously perform the another series of tasks in the second environment and complete the another operation, wherein the obtaining the input data is performed responsive to the robot autonomously performing the another series of tasks.

17. The non-transitory computer-readable medium of claim 15, wherein the input data comprises at least one of:
data from an operator obtained via a graphical user interface;
data from the operator obtained via a sensor;
data from another robot;
data representative of verbal commands provided by the operator;
data representative of gestures of the operator; or
data from a centralized device.

18. The non-transitory computer-readable medium of claim 15, wherein the first environment comprises a generic hospital and the second environment comprises a particular hospital.

19. The non-transitory computer-readable medium of claim 15, wherein the particular parameter indicates at least one of:
a rule corresponding to a series of tasks to be performed responsive to an event occurring;
a rule corresponding to a series of tasks being performed in a particular part of the second environment;
a rule corresponding to a modification to a series of tasks to be made responsive to an event occurring;
a rule corresponding to an order of operations for a series of tasks to be completed as part of a series of tasks; or
a rule corresponding to a series of tasks or a modification to a series of tasks to be made responsive to a particular operator being proximate to the robot.

20. The non-transitory computer-readable medium of claim 15, the operations comprising providing, to a plurality of robots, at least one of:
the input data to cause the plurality of robots to store the particular parameter in corresponding AI memories to permit the plurality of robots to execute stored AI models to identify series of tasks to be performed by the corresponding robot such that the series of tasks are performed in accordance with the general parameters corresponding to the first environment and in accordance with the stored particular parameter; or
the AI model with the particular parameter corresponding to the second environment stored in the AI memory.
